(19) United States
(12) Patent Application Publication
(10) Pub. No.: US 2008/0264297 A1
(43) Pub. Date: Oct. 30, 2008

(54) Concentrated Dye Solution

(76) Inventor: Rainhard Pedrazzi, Allschwil (CH)

Correspondence Address: CLARIANT CORPORATION;INTELLECTUAL PROPERTY DEPARTMENT, 4000 MONROE ROAD, CHARLOTTE, NC, 28205, US

(21) Appl. No.: 11/884,650

(22) PCT Filed: Feb. 14, 2006
(86) PCT No.: PCT/EP06/50932

§ 371 Date: Aug. 17, 2007

(30) Foreign Application Priority Data
Feb. 18, 2005 (EP) 05101243.3

(51) Int. Cl. C09D 11/02; C09B 45/24; C09B 35/50; C09B 44/08

(52) U.S. Cl. 106/31.48; 8/527

(57) ABSTRACT

Concentrated aqueous dye solutions comprising one or more cationizable dyes, an organic acid and water are useful for dyeing and/or printing organic substrates and for producing inkjet printing inks.

The present invention relates to a concentrated storage-stable colour-stable aqueous liquid dye solution and more particularly to a concentrated storage-stable aqueous dye solution without any solubilizer content. The invention further relates to the use of the present invention's concentrated dye solution, if appropriate after dilution with water, especially for dyeing and printing paper, including card and board.

Industrial dyeing and printing is typically carried out in an aqueous medium. Pulverulent dyes must accordingly first be dissolved in mostly warm or hot water to be usable for printing and dyeing.

Metering systems developed for this purpose utilize weighing or volumetric methods to control the metered addition of dyes and require stable dye solutions instead of powders and granules.

Such dye solutions have the advantage that they are easily meterable, do not dust and do not require costly dissolving operations.

The solutions should possess optimum stability, so that they do not precipitate during transportation or storage. Typically, they should be stable for a prolonged period between zero (0) and five (5) degrees Celsius (° C.), but also at around 50° C. Similarly, frozen solutions should remain stable after pouring and should not present any stability problems during pumping. Precipitates can cause disruptions in pumping or metering systems and lead to unacceptable machine shutdowns and costly cleaning and maintenance.

JP 06-306304 relates to an aqueous solution of a water-soluble dye which is purified with a reverse osmosis membrane made of polybenzimidazolone having a rejection rate by the membrane of 66% or lower and thereafter a dye dissolution aid is added to the solution. This dye dissolution aid consists essentially of a solution of 80 g molten urea stirred into one litre of distilled water comprising 50 g ethanol.

GB1438118 relates to aqueous dispersions of azo dyestuffs free from water-solubilizing groups which are prepared by coupling, in the presence of an anionic dispersing agent in amount from 20 to 500% of the theoretical weight of dyestuff.

EP0224910 relates to a process for preparing an aqueous-based ink composition for use in ink-jet printers wherein the solubility of acid dyes is increased in the acidic medium over that otherwise obtainable, due to the presence of the alkanol ammonium compound or cation amide compound.

EP0021619 relates to a method of making a concentrated aqueous solution of a dye containing one or more sulphonic acid groups comprising intimately contacting a first aqueous phase comprising an acidic solution of the dye with an organic phase comprising a solution, in an inert water-immiscible organic solvent, of an amine having a greater affinity for the solvent than for water, thereby extracting dye anion from the aqueous phase into the organic phase forming a solution of the amine salt of the dye in the organic solvent, and intimately contacting the organic phase with a second aqueous phase which comprises an aqueous solution of a base having greater affinity for water than for the organic solvent and has a higher pH than the first aqueous phase, thereby extracting dye anion from the organic phase into the second aqueous phase to form a concentrated aqueous solution of the salt of the dye and the base.

One problem of known aqueous dye solutions is the large amounts of added solubilizers, which lead to a high carbon content in the dyehouse or paper mill effluents. This leads to effluents of high total organic carbon (TOC) and chemical oxygen demand (COD), and hence causes high water-treating costs. It is accordingly an object of the present invention to provide a concentrated aqueous dye solution for whose preparation the dye does not have to be isolated and dried (high energy costs!) and which includes few or no solubilizers.

It has now been found that a concentrated aqueous dye solution without addition of solubilizers is storage stable when the dye is not isolated (process solution) but ultrafiltered (nanofiltered) to concentrate it and free it of superfluous chloride ions and the desalting and concentrating is done at moderate temperatures, the pH of the resulting solution being adjusted to a value of around pH=3. The liquid dye solutions thus obtained are not only storage stable but also colour stable, i.e. the colour does not change during storage. Alternatively, with similar results, pulverulent or granulated dye can be redissolved instead of a process solution being used, and then ultrafiltered (nanofiltered) to concentrate it and free it of superfluous chloride ions.

The concentrated aqueous liquid dye solutions of the present invention comprise one or more cationizable dyes, an organic acid and/or inorganic acid and water and have an at most equimolar chloride ion fraction based on the dye present in the solution.

Preferred concentrated aqueous liquid dye solutions of the present invention comprise (i) one or more cationizable dyes of the formula (I):

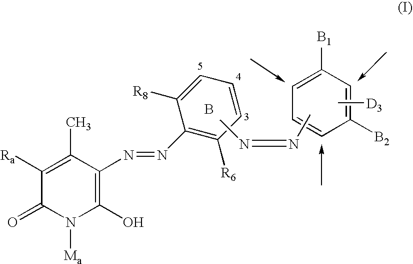

where B₁ and B₂ are independently —OH and NH₂ and D₃=H or a radical of the formula

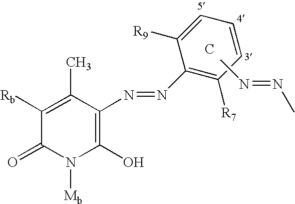

and
R₆, R₇, R₈ or R₉ are independently H or —SO₃H and
Mₐ or M_{b} independently have the meanings of M₁ to M₁₀, where

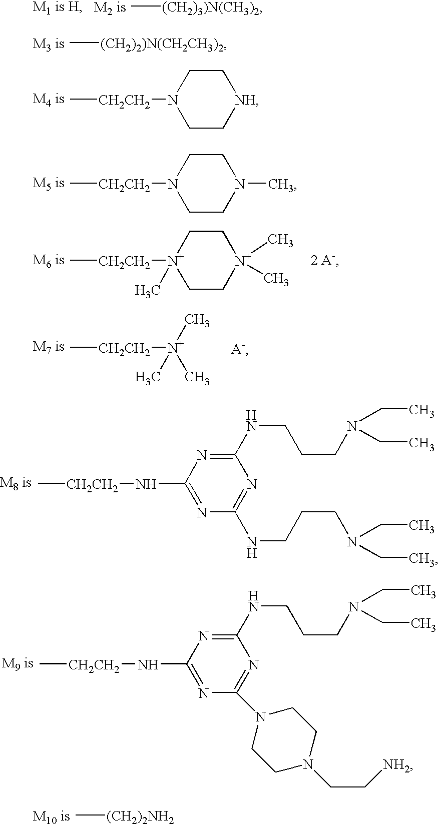

and
Rₐ or R_{b} independently have the meanings of R₁ to R₅

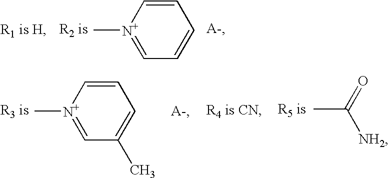

where A⁻ is a non-coloured anion which is the anion of an organic acid and/or the anion of an inorganic acid and
(ii) an organic acid and/or an inorganic acid and
(iii) water and
(iv) having an at most equimolar chloride ion fraction based on the dye present in the solution.

The dyes of the formula (I) are known per se and can be prepared as described in DE3715066.

The present invention's storage-stable high-concentration solutions of dyes of the formula (I) have a formula (I) dye content of up to 40% by weight of dye reckoned on the total weight of the solution. Preferred dye solutions have a dye content in the range from 5% to 40% by weight of dye or a dye content in the range from 10% to 40% by weight of dye and most preferably a dye content in the range from 20% to 40% by weight of dye.

The concentrated aqueous liquid dye solutions of the present invention preferably have a chloride content of not more than equimolar based on the dye present in the solution, the chloride content being preferably in the range from 0.5 to 1 mol equivalent based on the dye present in the solution and more preferably in the range from 0.8 to 1 mol equivalent based on the dye present in the solution.

The preferred dye solutions of the present invention are acidic and preferably have a pH of 3 plus/minus one pH unit. Very particular preference is given to dye solutions having a pH of 3 plus/minus half a pH unit, the pH of the solution obtained being preferably adjusted to a value in the range from pH 2.9 to pH 3.1.

The present invention's storage-stable high-concentration solutions of dyes of the formula (I) may also comprise a plurality of dyes whose formulae come within the formula (I).

Preferred organic acids are acids of the formula A(—COOH)ₙ where A is C₁₋₁₂-alkanyl or C₁₋₁₂-alkenyl which may each be interrupted by nitrogen atoms and or oxygen atoms and which may each be additionally substituted by hydroxyl or NR′R″ (where R′ and R″ are independently C₁₋₆-alkanyl or C₁₋₆-alkenyl or C₁₋₆-hydroxyalkanyl or C₁₋₆-hydroxyalkenyl, or unsubstituted phenyl or hydroxyl- or sulpho- or C₁₋₁₈-alkanyl- or C₁₋₁₈-alkenyl-substituted phenyl) and with n as a natural number of 1, 2 or 3. n is preferably=1 or 2 and more preferably =1.

Particular preference is given to formic acid, acetic acid, malonic acid, propionic acid, lactic acid, tartaric acid, benzoic acid, succinic acid. Acetic acid is the most preferred organic acid.

The preferred inorganic acids are the mineral acids and the inorganic oxoacids. Particular preference is given to halohydric acids (hydrochloric acid is particularly preferred), oxygen acids of the halogens (F, Cl, Br, I), oxygen acids of sulphur (but in particular sulphuric acid) and the oxygen acids of group 15 of the periodic table (in accordance with the 1985 IUPAC recommendation) (but in particular those derived from the elements nitrogen and phosphorus), but in particular hydrochloric acid, sulphuric acid, chloric acid, phosphoric acid and nitric acid, and phosphoric acid is very particularly preferred.

These acids will be present in a partially deprotonated (dissociated) state, as would be expected from their pK value and from the pH value of the dye solution.

Examples of preferred non-coloured anions are chlorides, bromides, sulphates, bisulphates, methosulphates, aminosulphonates, perchlorates, benzenesulphonates, oxalates, malonates, maleates, acetates, propionates, lactates, succinates, tartrates, malates, methanesulphonates and benzoates. But also complex anions such as for example zinc chloride double salts and anions of boric acid, citric acid, glycolic acid, diglycolic acid and adipic acid or addition products of orthoboric acid with polyalcohols having at least one cis diol group. These anions may of course also be exchanged, for example by means of ion exchangers or customary precipitation reactions. The ions can also be exchanged by diafiltration or ultrafiltration. The halides chloride and bromide are particularly preferred anions and chloride is most preferred.

In principle, the salts of the added organic and/or inorganic acids can likewise perform the anion function. In a particularly preferred embodiment, the anions are chlorides and the added acid is phosphoric acid.

The invention also provides a process for producing the concentrated storage-stable colour-stable aqueous liquid dye solutions characterized in that an aqueous solution or suspension of at least one crude cationic dye is membrane filtrated, using a semipermeable membrane, by applying a pressure to remove salts and synthesis by-products having molecular weights below 500 and some water. This process is performed until the chloride ion fraction is at most equimolar with regard to the dye.

In a preferred embodiment, the permeate is continuously or intermittently replaced or supplemented by water or buffer solution so that the volume of the batch changes only minimally, if at all. In other words, the dye concentration remains constant or substantially constant. The dye concentration of the permeate does not change by more than 20% in a preferred embodiment, by not more than 10% in particularly preferred processes and by not more than 5% in very particularly preferred processes.

Following this diafiltration or ultrafiltration, the dye solution is brought to the desired concentration by concentrating.

The membranes used in the process of the present invention are TFM™ membranes, for example the G10, G20, G50 or DL5 membranes from GE Osmonics Desal (GE Osmonics Inc., 5951 Clearwater Drive, Minnetonka, Minn. 55343, United States), of which the DL5 membrane is particularly preferred.

In a further, preferred version, the counterions of the cationic dye are exchanged, or further anions added, prior to diafiltration. The newly added anions mean that the original anions are easily removable through ultrafiltration or diafiltration. The counterions of the cationic functions are exchanged by halides in a particularly preferred embodiment and by chloride in a very particularly preferred embodiment.

The present invention further provides a process for the production of concentrated storage-stable colour-stable aqueous liquid dye solutions of cationic dyes by ultrafiltration of the aqueous solution or suspension of the crude dye.

The present invention further provides concentrated storage-stable colour-stable aqueous liquid dye solutions obtainable by the process of this invention.

Ultrafiltration or diafiltration of the reaction solution, which is obtained as per the examples of DE3715066, although the dyestuff is not isolated, can be used to render the reaction solution free of further, undesirable additions. Free of undesirable additions is to be understood as meaning in particular that, after ultrafiltration or diafiltration, the solutions comprise less than one % by weight and preferably less than 0.5% by weight of further materials. Undesirable further materials are in particular inert salts and electrolytes which, having been used to neutralize and/or salt out the dye, come from the synthesis stage and are carried along in the synthesis solution or suspension. Alkali metal or alkaline earth metal salts, for example ammonium, magnesium chloride, magnesium sulphate, magnesium bisulphate, sodium chloride, sodium sulphate, sodium bisulphate, potassium chloride, potassium sulphate or potassium bisulphate, especially sodium chloride, shall not be present in excess, i.e. in a larger amount than in an equimolar amount.

The preferred process of the present invention comprises the following steps:

A first step of ultrafiltration/diafiltration of the aqueous reaction solution, which contains 5% to 13% by weight of the substance of the formula (I), preferably 8% to 11% by weight, at a pH of between 5.5 and 6.5 and preferably 5.9 and 6.1, at a temperature of between 20 and 50 degrees Celsius and preferably between 30 and 35 degrees Celsius.

The ultrafiltration/diafiltration is preferably run at a continuously increasing temperature until not more than 35 degrees Celsius is reached. The ultrafiltration is carried out at a diafiltration rate of about 2, but at least until the chloride ion fraction is equimolar or somewhat less than equimolar. The ultrafiltration is preferably not carried out at temperatures above 35 degrees Celsius.

A further step comprises concentrating the solution to a concentration of not more than 40% by weight of the dye of the formula (I), but at least to 20% by weight of the dye of the formula (I). The concentrating rate is about 1.5 or up to the desired concentration. The concentrating is preferably carried out at a constant temperature between 30 and 35 degrees.

The pH is adjusted at the third step. Immediately following the diafiltration and concentration, the chloride ion fraction is adjusted to not more than the equimolar fraction, based on the dye molecule of the formula (I), by addition of hydrochloric acid. Thereafter, the pH is adjusted with an organic acid and/or an inorganic acid to pH 3 plus/minus one pH value, preferably to pH 3 plus/minus 0.5 pH value. The pH is most preferably adjusted to between pH 2.9 to pH 3.1. Preferred acids for adjusting the pH include the hereinabove mentioned inorganic and/or organic acids, but in particular the following acids: phosphoric acid, formic acid, acetic acid or lactic acid.

One of the acids mentioned can also be used to adjust the pH directly, without hydrochloric acid addition, in which case the required amount of the organic acid and/or inorganic acid is added. In principle, the organic acid can also be added before or during the ultrafiltration/diafiltration.

By preference the concentrated storage-stable colour-stable aqueous liquid dye solutions according to the invention are free or substantially free of dispersing agents other than the organic acids identified above.

As well as the water-soluble, organic acids identified, the dye solutions of the present invention may comprise biocides.

Any biocide is suitable. But preference is given to biocides having FDA approval. Any biocide capable of controlling the growth of Gram-positive or Gram-negative bacteria, yeasts or fungi can be used in the solutions of the present invention. Suitable biocides are for example 3-thiazolone derivatives, which are for example alkylated and/or chlorinated or used as mixtures. Typically, biocides are added in an amount of up to 0.15% by weight per ready-produced composition.

The concentrated solutions can also be diluted again with water before they are used for dyeing. The concentrated solutions can also be shaded with further dyes before use. But the concentrated solutions can also be used for shading other dyes.

Dyes especially useful for shading or for being shaded include all dyes which the Colour Index identifies as C.I. Basic Yellow or C.I. Basic Red or C.I. Basic Brown or C.I. Basic Blue or C.I. Basic Violet, and especially one or more of the following dyes can be used for shading: C.I. Basic Brown 23 or C.I. Basic Red 12 or C.I. Basic Blue 1 or C.I. Basic Red 14 or C.I. Basic Violet 10 or C.I. Basic Blue 26.

Dyes of the formula (II) and/or of the formula (III) are similarly useful for shading or for being shaded.

The concentrated solutions can also be used for shading brown dyes of the formula (II), or the concentrated solutions can be shaded with dyes of the formula (II).

The dyes of the formula (II) have the following structure:

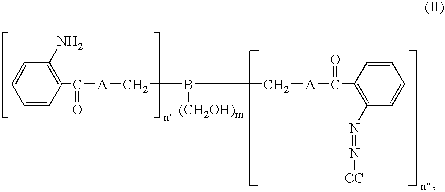

where
each A is independently —NH— or —O—,
B is a polyvalent group or atom,
n′ and n″ are natural numbers and the sum total of n′ and n″ is ≧2,
m is a natural number ≧0,

CC is a group having the formula (c₁) or (c₂)

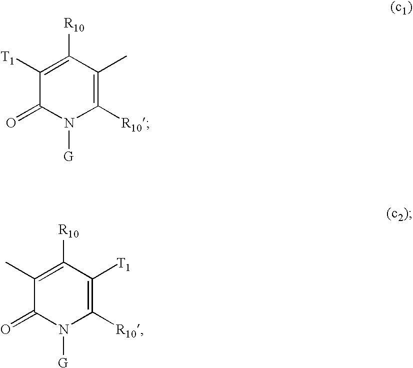

where
each R₁₀ is independently H; C₁₋₄alkyl; C₅₋₆cycloalkyl; phenyl, benzyl or phenylethyl,
each R₁₀′ is independently H; —OH or C₁₋₄alkyl
each T₁ is independently H; —CN; —COOR₁₅; CONR₁₆R₁₇; SO₂NR₁₆R₁₇;

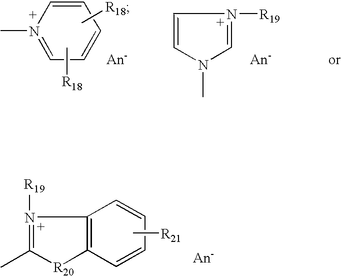

G is H; —R₁₁NHR₁₂ or —R₁₁NR₁₃R₁₄, where
R₁₁ is C₁₋₆alkylene or C₂₋₆alkenylene,
R₁₂ and R₁₃ are independently H; unsubstituted C₁₋₆alkyl; C₂₋₆alkyl substituted by OH, CN or halogen; phenyl-C₁₋₃alkyl, where the phenyl radical is optionally singly, doubly or triply substituted by substituents selected from the group consisting of chlorine, C₁₋₄alkyl or C₁₋₄alkoxy; unsubstituted C₅₋₆cycloalkyl or C₅₋₆cycloalkyl singly, doubly or triply substituted by C₁₋₄alkyl groups,
R₁₄ has meaning as for R₁₂ or R₁₃ or a hydrogen atom,
R₁₅ is C₁₋₆alkyl radical or phenyl-C₁₋₃alkyl radical,
R₁₆ and R₁₇ are independently H or a C₁₋₄alkyl radical,
R₁₈ is in each occurrence independently H; C₁₋₄alkyl radical; —NR₁₆R₁₇—(CH₂)₂₋₄—NR₁₆R₁₇ or —CONR₁₆R₁₇,
R₁₉ is a C₁₋₄alkyl radical or a hydroxy-C₁₋₄alkyl radical,
R₂₀ is —S— or —O—,
R₂₁ is a hydrogen atom or a C₁₋₄alkyl radical and
An⁻ is a non-coloured anion,
   with the conditions that
   (i) the sum total of n′, n″ and m is less than the number of valences of B,
   (ii) when the sum total of n′ and n″=2, then m is ≧1,
   (iii) when the sum total of n′ and n″=3 and A=NH, then m≧1, an organic acid and water.

The invention's storage-stable high-concentration solutions of dyes of the formula (II) may also comprise a plurality of different dyes whose formulae come within the formula (II).

In preferred dyes of the formula (II), T₁ is a substituent of the formula

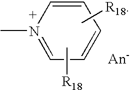

In more preferred dyes, the group CC is a substituent of the formula

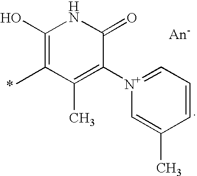

Preferably, B is a group B′C[(CH₂)₀₋₄]₁₋₄ or B is one of the groups —[—(CH₂)₁₋₄—O—(CH₂)₁₋₄]₄C or [—(CH₂)₁₋₃—O—(CH₂)₁₋₃—O—(CH₂)₁₋₃]₄C or [—(CH₂)₁₋₂—O—(CH₂)₁₋₂—O—(CH₂)₁₋₂—O—(CH₂)₁₋₂]₄C or [(—CH₂)₁₋₄]₂N(CH₂)₁₋₄N[(—CH₂)₁₋₄]₂. It is particularly preferable for B to be a carbon atom.

Particularly preferred compounds of the formula (II) have the formula (IIa)

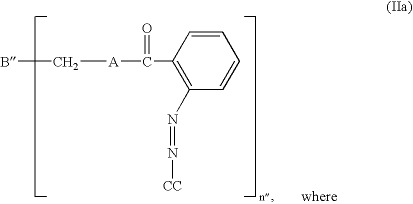

CC is a substituent of the formula (c₁) or (c₂) and
n″ is 1, 2, 3 or 4, with to the conditions that
when n″=1, then B″ is C(CH₂OH)₃,
when n″=2, then B″ is C(CH₂OH)₂,
when n″=3, then B″ is C(CH₂OH),
when n″=4, then
B″ is C; [—(CH₂)₁₋₄—O—(CH₂)₁₋₄]₄C; [—(CH₂)₁₋₃—O—(CH₂)₁₋₃—O—(CH₂)₁₋₃]₄C; [—(CH₂)₁₋₂—O—(CH₂)₁₋₂—O—(CH₂)₁₋₂—O—(CH₂)₁₋₂]₄C or [(—CH₂)₁₋₄]₂N(CH₂)₁₋₄N[(—CH₂)₁₋₄]₂.

Very particular preference is given to compounds of the formula (IIa) where CC is a substituent of the formula (c₁) or (c₂) and
n″ is 1, 2, 3 or 4, with to the conditions that
when n″=1, then B″ is C(CH₂OH)₃
when n″=2, then B″ is C(CH₂OH)₂,
when n″=3, then B″ is C(CH₂OH),
when n″=4, then B″ is C.

The concentrated solutions can also be used for shading brown dyes of the formula (III), or the concentrated solutions can be shaded with dyes of the formula (III).

The dyes of the formula (III) have the following structure:

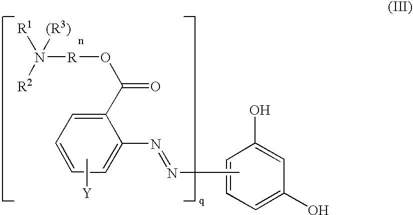

where
R¹, R² or R³ are independently H, CH₃, C₂H₅, n-C₃H₇, i-C₃H₇, n-C₄H₉, i-C₄H₉, sec-C₄H₉,

### Rⁿ is —C₂H₄—, —C₃H₆—, —CH(CH3)CH₂— or —C₄H₆—

Y is hydrogen or nitro,
q is 1 or 2.

The dyes of the formula (II) are known and can be prepared as described in WO02/062902. The dyes of the formula (III) are known and can be prepared as described in EP162409 or EP1352928.

Shading can be effected in the ratios of 2% to 98% by weight (based on the dye) of a dye of the formula (I) and 98% to 2% by weight (based on the dye) of a shading dye, i.e. for example in the ratios 2.0/98.0; 2.5/97.5; 12.5/87.5; 22.5/77.5; 32.5/67.5; 42.5/57.5; 50.0/50.0; 57.5/42.5; 67.5/32.5; 77.5/22.5; 80.0/20.0; 87.5/12.5; 90.0/10.0; 95.0/5.0; 97.5/2.5; or 98.0/2.0.

The concentrated dye solutions of the present invention are used in particular, if appropriate after dilution with water, for dyeing and printing paper, including board and card, these materials being dyeable for example in the pulp, by coating or by dipping. In addition, such a liquid formulation can also be used for a continuous or batch dyeing process for textile materials, especially cellulose. The concentrated dye solutions of the present invention can be used as a base for producing inkjet inks or other inks and combinations for the non-impact printing of substrates such as paper or textiles. The formulations of the present invention can also be used without further modification for the non-impact printing of substrates such as paper or textiles.

The dye preparations of the present invention can also be used for dyeing and tinting wood. The wood can be in the form of articles, such as bowls, dishes, toys, but also solid slats and beams, and also in the form of shavings, chips or chipboard. Parts of buildings can similarly be treated with the dye preparations of the present invention, as can furniture. The application of the liquid dye preparations of the present invention can be utilized for equalizing colour differences in the wood or in a veneer, but also for completely changing the colour of the wood or of a veneer. The liquid dye preparations of the present invention can be utilized as an aqueous stain (in which case water is the main solvent), as an alcoholic-aqueous stain (i.e. the solvent is an alcohol-water mixture) or as stains involving organic solvents (about 30-95% of organic solvents; such stains may also possibly be water thinnable).

The examples which follow illustrate the invention. Parts and % ages are by weight, unless stated otherwise.

### PREPARATION EXAMPLE A1

30 parts of 4-aminoacetanilide are conventionally diazotized at 0-5° C. and coupled at pH 1.3 to 2.1 onto 57.4 parts of 6-hydroxy-4-methyl-1-(3′-dimethylamino)propyl-3-pyridinio-2-pyridone betaine base. The acetyl group is detached at the boil by addition of 50 parts of 30% hydrochloric acid and the solution is subsequently cooled down to room temperature=solution 1 (about 670 parts).

91 parts of 3-aminoacetanilide are conventionally diazotized at 0-5° C. and coupled at pH 1.3 to 2.1 with 174 parts of 6-hydroxy-4-methyl-1-(3′-dimethylamino)propyl-3-pyridinio-2-pyridone betaine base. The acetyl group is detached under reflux by addition of 160 parts of 30% hydrochloric acid and the solution is subsequently cooled down to room temperature=solution 2 (about 1800 parts).

Solution 1 is then diazotized at 0-5° C. by known methods, followed by solution 2 being diazotized at 0-5° C. by known methods, and subsequently the two diazonium solutions are combined. 44 parts of resorcinol are added and the pH is adjusted to about 7 with 30% aqueous sodium hydroxide solution. The coupling ends after 2-3 hours, leaving about 4000 parts of a brown dye solution containing about 400 parts of the dye of the formula

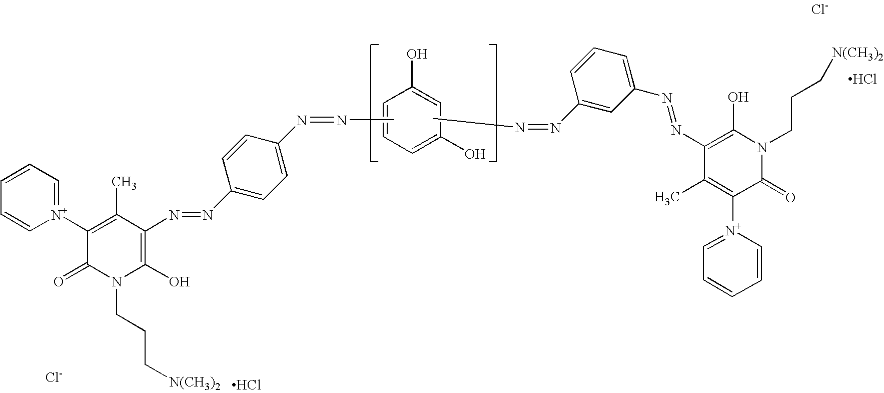

The conversion into a storage-stable and colour-stable solution is done as follows. The solution is adjusted to an accurate pH between 5.9 and 6.1 (either with hydrochloric acid or with aqueous sodium hydroxide solution), while the temperature of the solution is maintained between 10 and 20° C. Lastly, the temperature is allowed to rise (i.e. raised by a little heating) to between 30 and 35° C. and a start is made on the diafiltration, for which the temperature must not exceed 35° C. To this end, the dye solution is diafiltered in a laboratory ultrafiltration system equipped with a DL5 membrane at a temperature of between 30 and 35° C. and a pressure of 15 bar until the conductivity in the permeate remains constant, i.e. the chloride ion fraction has decreased to between 10% and 12% based on the dye molecule, which corresponds to a substantially equimolar chloride ion content. Althewhile, the volume is kept substantially constant. The retentate is concentrate at a pressure of 12 to 15 bar, hydrochloric acid is used to adjust the chloride ion content to 13%, based on the dye molecule with the molar mass 1090, in the form of the HCl/chloride salt, and the pH decreases to about 3.3. The pH is then accurately adjusted (buffered) to 3 (2.9-3.1) by addition of acetic acid to obtain a solution having a total dye content of about 20% by weight, that is stable in storage and does not undergo any hue change even during prolonged storage periods, i.e. is colour stable. This storage-stable and colour-stable solution dyes wood-containing paper in brown shades.

### PREPARATION EXAMPLE A2

22.1 parts of ( 1/20 mol) of the compound of formula

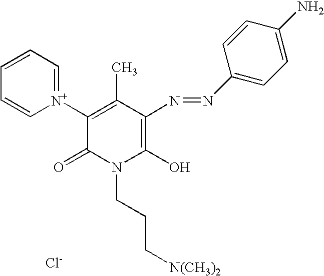

are diazotized at 0-5° C. with 3.45 parts of sodium nitrite ( 1/20 mol) in a hydrochloric acid medium and coupled at a pH of 1-3 onto 5.4 parts of 1,3-diaminobenzene ( 1/20 mol) to obtain the dye of the formula (A2a)

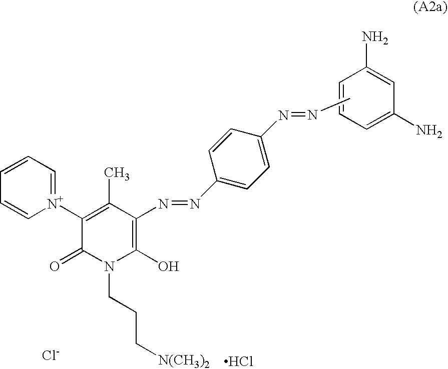

Coupling 26.1 parts ( 1/20 mol) of the diazonium salt of the compound of the formula (A2b)

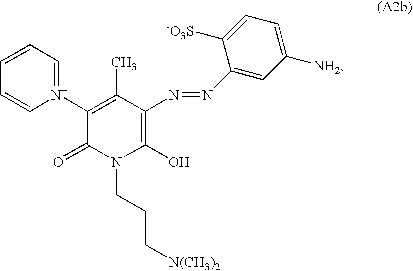

prepared by known methods by diazotization and coupling of 1-amino-3-acetyl-aminobenzene-6-sulphonic acid onto pyridone and subsequent saponification, onto the dye of the formula (A2a) provides an isomer mixture of the dye of the formula:

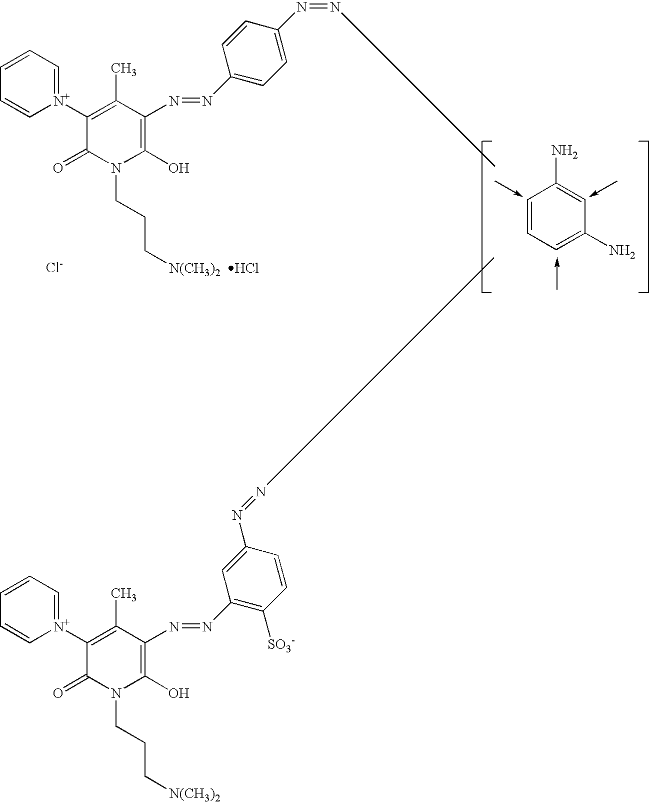

(The possible coupling sites are marked by arrows).

This isomer mixture dyes wood-containing paper in brown shades. A storage-stable and colour-stable solution is prepared from this isomer mixture similarly to Preparation Example A1.

Table I below indicates the constitutional construction of further dyes preparable according to Preparation Example A2. These dyes too were prepared similarly to Preparation Example A1 or A2 and purified and converted into storage-stable liquid formulations according to Preparation Example A1. The storage-stable liquid formulations thus obtained dye paper in brown shades. They conform to the formula A2c:

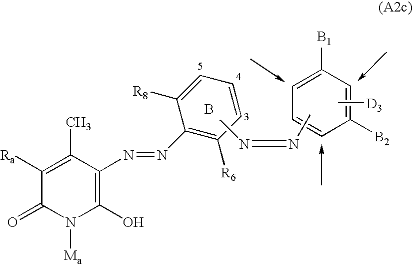

where B₁ and B₂ are independently —OH and NH₂ and D₃=H or a residue of the formula

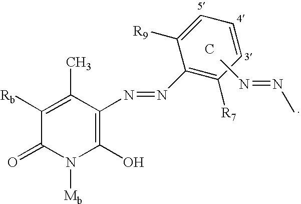

Table for Mₐ and M_{b}

| | |
|---|---|
| M₁ | H |
| M₂ | —(CH₂)₃)N(CH₃)₂ |
| M₃ | —(CH₂)₂)N(CH₂CH₃)₂ |
| M₄ | 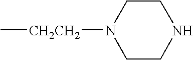 |
| M₅ | 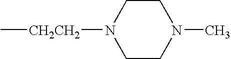 |
| M₆ | 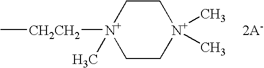 |
| M₇ | 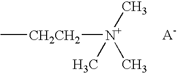 |
| M₈ | 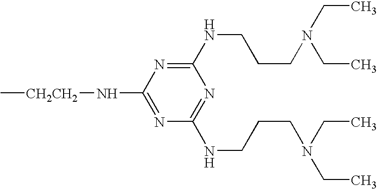 |
| M₉ | 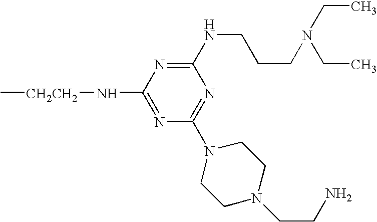 |
| M₁₀ | —(CH₂)₂)NH₂ |

Table for Rₐ and R_{b}

| | |
|---|---|
| R₁ | H |
| R₂ | 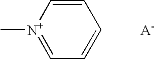 |
| R₃ | 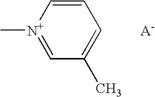 |
| R₄ | CN |
| R₅ | 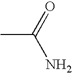 |

TABLE I

| Ex. | | | | | Position of azo bridge 1 | H or | | | | | Position of azo bridge 2 | | |
|---|---|---|---|---|---|---|---|---|---|---|---|---|---|
| No. | Rₐ | Mₐ | R₆ | R₈ | in ring B | D₃ | R_{b} | M_{b} | R₇ | R₉ | in ring C | B₁ | B₂ |
| A3 | R₂ | M₂ | SO₃H | H | 3 | H | — | — | — | H | — | OH | OH |
| A4 | R₂ | M₂ | SO₃H | H | 4 | H | — | — | — | H | — | OH | NH₂ |
| A5 | R₂ | M₂ | SO₃H | H | 4 | H | — | — | — | H | — | NH₂ | NH₂ |
| A6 | R₂ | M₂ | SO₃H | H | 3 | D₃ | R₂ | M₂ | SO₃H | H | 3′ | NH₂ | NH₂ |
| A7 | R₂ | M₂ | SO₃H | H | 3 | D₃ | R₂ | M₂ | H | H | 4′ | NH₂ | NH₂ |
| A8 | R₂ | M₂ | SO₃H | H | 3 | D₃ | R₂ | M₂ | H | H | 4′ | NH₂ | NH₂ |
| A9 | R₂ | M₂ | SO₃H | H | 3 | D₃ | R₂ | M₂ | H | H | 4′ | NH₂ | OH |
| A10 | R₂ | M₂ | SO₃H | H | 3 | D₃ | R₂ | M₂ | H | H | 4′ | OH | OH |
| A11 | R₂ | M₂ | SO₃H | H | 4 | D₃ | R₂ | M₂ | H | H | 3′ | NH₂ | NH₂ |
| A12 | R₃ | M₁ | H | H | 3 | D₃ | R₂ | M₂ | SO₃H | H | 4′ | NH₂ | NH₂ |
| A13 | R₁ | M₄ | H | H | 3 | D₃ | R₂ | M₅ | SO₃H | H | 4′ | OH | NH₂ |
| A14 | R₄ | M₄ | H | H | 3 | D₃ | R₂ | M₆ | SO₃H | H | 4′ | NH₂ | NH₂ |
| A15 | R₅ | M₄ | H | H | 3 | D₃ | R₂ | M₇ | SO₃H | H | 4′ | NH₂ | NH₂ |
| A16 | R₂ | M₂ | SO₃H | H | 4 | D₃ | R₂ | M₂ | H | H | 3′ | OH | NH₂ |
| A17 | R₂ | M₂ | SO₃H | H | 4 | D₃ | R, | M₂ | H | H | 3′ | OH | OH |
| A18 | R₂ | M₈ | SO₃H | H | 4 | D₃ | R₂ | M₁ | H | H | 3′ | OH | OH |
| A19 | R₂ | M₈ | SO₃H | H | 4 | D₃ | R₂ | M₂ | H | H | 3′ | OH | NH₂ |
| A20 | R₂ | M₈ | H | H | 4 | D₃ | R₂ | M₄ | SO₃H | H | 3′ | NH₂ | NH₂ |
| A21 | R₂ | M₉ | H | H | 4 | D₃ | R, | M₅ | SO₃H | H | 3′ | OH | NH₂ |
| A22 | R₂ | M₉ | H | H | 3 | D₃ | R₄ | M₃ | SO₃H | H | 4′ | ₀H | OH |
| A23 | R₂ | M₈ | H | H | 3 | D₃ | RS | M₄ | SO₃H | H | 4′ | NH₂ | NH₂ |
| A24 | R₂ | M₃ | H | H | 4 | D₃ | R₃ | M₃ | SO₃H | H | 3′ | Nil, | NH₂ |
| A25 | R₂ | M₂ | H | CH₃ | 3 | D₃ | R₂ | M₂ | SO₃H | H | 4′ | OH | OH |
| A26 | R₂ | M₃ | H | CI | 3 | D₃ | R₂ | M₃ | SO₃H | H | 4′ | NH₂ | NH₃ |
| A27 | R₂ | M₂ | H | OCH₃, | 3 | D₃ | R₂ | M₄ | SO₃H | H | 4′ | NH₂ | NH₂ |
| A28 | R₂ | M₇ | SO₃H | H | 4 | D₃ | R₂ | M₇ | H | Cl | 3′ | OH | OH |
| A29 | R₂ | M₈ | SO₃H | H | 4 | D₃ | R₂ | M₂ | H | CH₃ | 3′ | OH | NH₂ |
| A30 | R₂ | M₆ | SO₃H | H | 4 | D₃ | R, | M₂ | H | OCH₃ | 3′ | NH₂ | NH₂ |
| A31 | R₂ | M₂ | SO₃H | H | 3 | D₃ | R₂ | M₂ | H | H | 3′ | OH | NH₂ |
| A32 | R₂ | M₂ | SO₃H | H | 4 | D₃ | R₂ | M₂ | H | H | 4′ | NH₂ | NH₂ |
| A33 | R₂ | M₂ | SO₃H | H | 4 | D₃ | R₂ | M₂ | SO₃H | H | 4′ | NH₂ | NH₂ |
| A34 | R₂ | M₂ | SO₃H | H | 3 | D₃ | R₂ | M₂ | H | H | 3′ | NH₂ | NH₂ |
| A33 | R₂ | M₂ | SO₃H | H | 4 | D₃ | R₂ | M₂ | H | H | 4′ | NH₂ | OH |
| A34 | R₂ | M₂ | SO₃H | H | 3 | D₃ | R₂ | M₂ | SO₃H | H | 4′ | OH | NH₂ |
| A35 | R₂ | M₁₀ | SO₃H | H | 3 | D₃ | R₂ | M₂ | H | H | 3′ | OH | OH |

### PREPARATION EXAMPLE A36

425 parts of isatoic anhydride are added gradually at 50° C. to a mixture of 118 parts of pentaerythritol and 8.7 parts of sodium carbonate in 434 parts of N,N-dimethyl-acetamide. The suspension is stirred for 2 hours and diluted with 4340 parts of water. This is followed by filtration, washing with water and drying at 60° C. under reduced pressure to obtain a white powder which is a mixture consisting of 4 components having the formulae (36a, 36b, 36c, 36d):

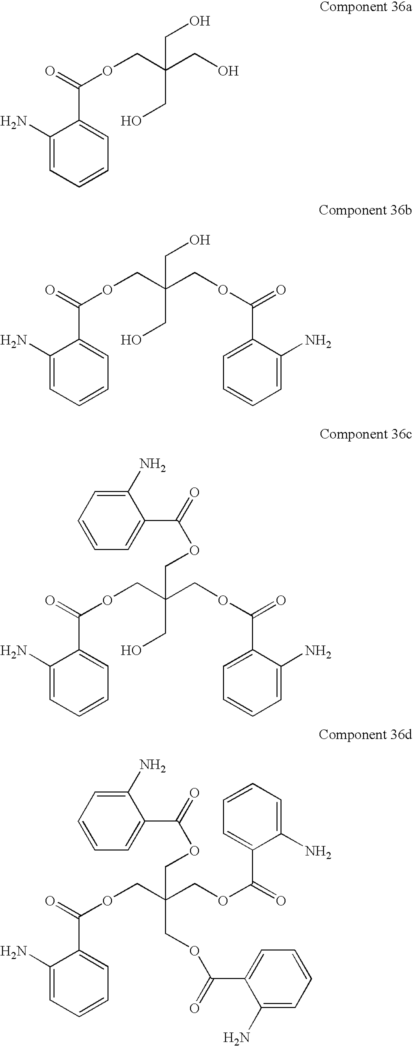

### PREPARATION EXAMPLE A37

434 parts of the amino components of Example A36 are added to a mixture of 1736 parts of ice, 781 parts of 30% HCl, 694 parts of acetic acid and 260 parts of N,N-dimethylacetamide and are diazotized with 182 parts of a 4 N sodium nitrite solution. The temperature is maintained at 0-5° C. by addition of 870 parts of ice. To the diazo solution obtained are added 3281 parts of an approximately 20% aqueous solution of 6-hydroxy-4-methyl-3-pyridonyl-3′-methylpyridinium chloride. The pH is adjusted to 3 at a temperature of 10-20° C. by addition of 130 parts of 30% sodium hydroxide solution. After subsequent stirring for 1 hour, 50 parts of Hyflo-Supercel filter earth are added before filtration through a porcelain suction filter with absorbent pad. The clear dye solution obtained (9700 g; 8900 ml) is diafiltered in a laboratory ultrafiltration system having a DL5 membrane at 40-45° C. and a pressure of 15 bar until the conductivity in the permeate stays constant. In the process, the volume is kept substantially constant. This required about 33 000 parts (ml) of demineralized water. The pH is maintained at 4.0-4.5 during the ultrafiltration by addition of acetic acid. The retentate is concentrated at a pressure of 12-15 bar to 5180 parts (g) and then admixed with 140 parts of acetic acid to obtain a solution having a total dye content of about 20% by weight, consisting of the components having the formulae (37a, 37b, 37c, 37d):

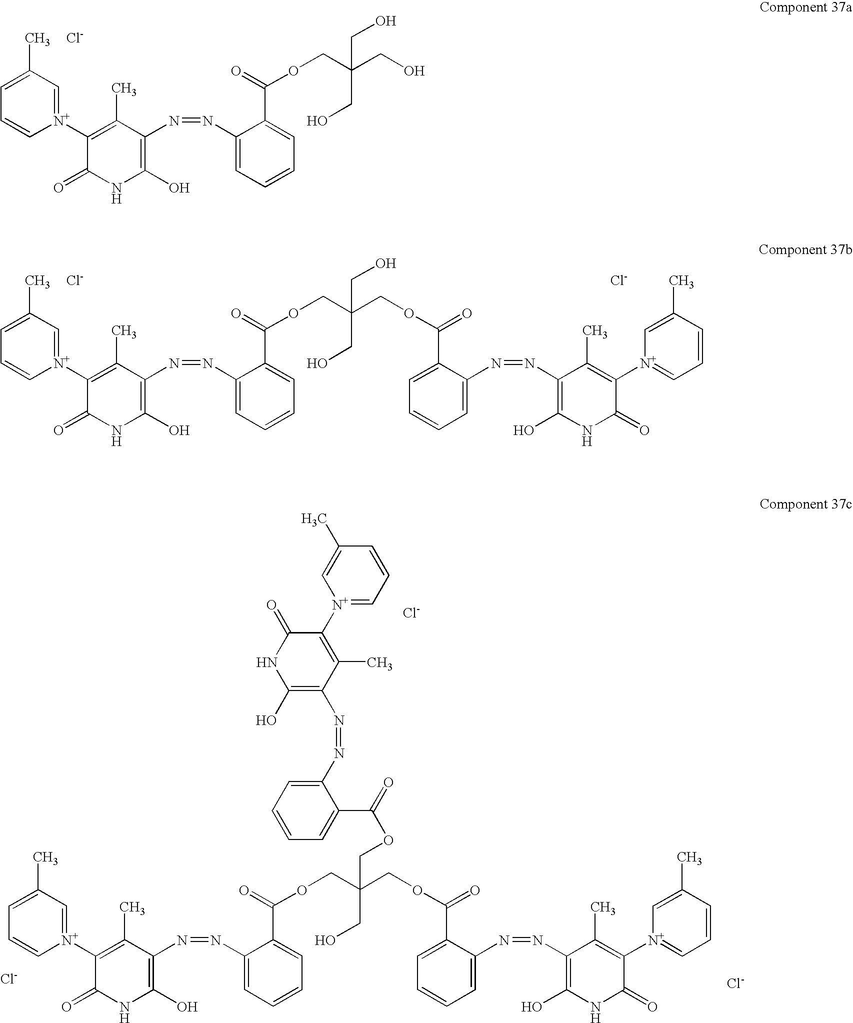

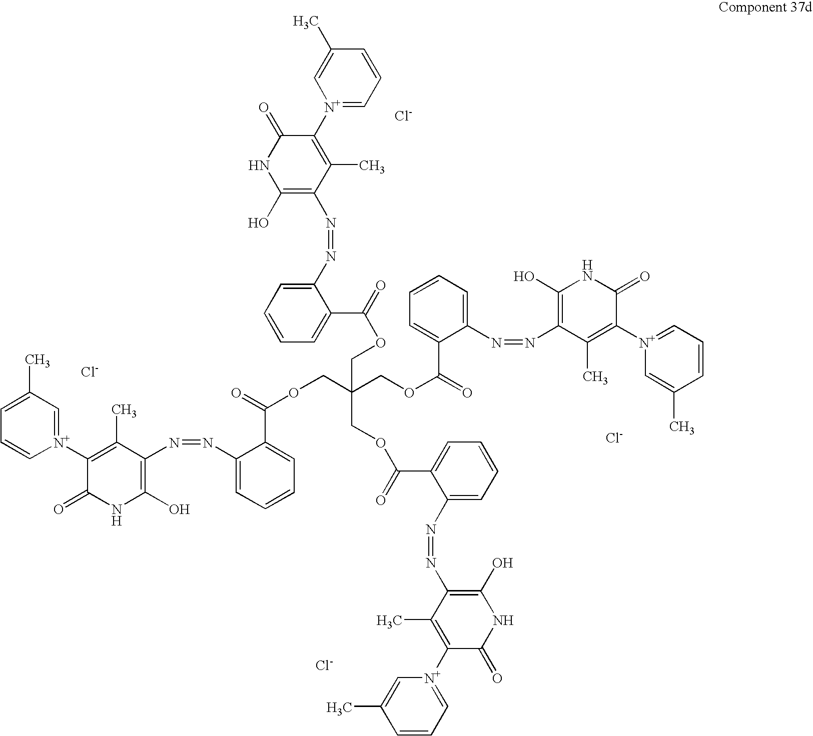

This solution (20.7% dye as chloride, 5.5% of acetic acid, 73.8% of water) dyes paper in a brilliant yellow hue (λ_{max.}=423 nm in dimethylformamide/water), the concentrated solution being dilutable if necessary. The dyeings obtained have excellent wet fastnesses (to plain water, alcohol, milk, soapy water, acetic acid, urine, etc.)

### PREPARATION EXAMPLE A38

Preparation of the diazo component: to 326 parts of isatoic anhydride in 1000 parts of dioxane are added dropwise 187 parts of dimethylaminoethanol at 60° C. Subsequent stirring for 1 hour is followed by concentrating in a water jet vacuum and distilling in a fine vacuum. 402 parts of 2′-dimethylaminoethyl anthranilate pass over at 160° C./0.1 Torr.

21 parts of 2′-dimethylaminoethyl anthranilate are dissolved in a mixture of 50 parts of water, 25 parts of glacial acetic acid and 30 parts of concentrated hydrochloric acid and, after cooling to 5° C., admixed with 34.6 parts of a 23% aqueous solution of sodium nitrite added dropwise. After three hours, excess nitrite is destroyed by addition of sulphamic acid. A solution of 11 parts of resorcinol in 30 parts of warm water is then added, the pH is raised with sodium acetate to pH 5 and the batch is stirred at room temperature overnight. After cooling to 0° C., the batch is gradually adjusted to pH 7 with 5N caustic soda. After 4 hours, the dye obtained is through crystallized and can be filtered off with suction and washed with water. Air drying yields 22 g of dye powder. The dye can be dissolved with glacial acetic acid and water to form a stable 20% liquid formulation. The dye dyes paper in a yellow hue. The hue is No. 4 on the Colour Index Hue Indication Chart. The effluent is only minimally coloured. The dyed papers can be bleached by means of hydrosulphite. The dissolved compound conforms to the formula

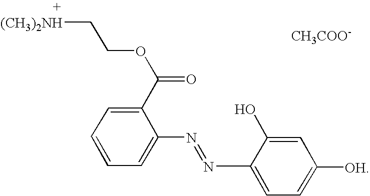

### PREPARATION EXAMPLE A39

Preparation of the diazo component: to 326 parts of isatoic anhydride in 1000 parts of dioxane are added dropwise 187 parts of dimethylaminoethanol at 60° C. Subsequent stirring for 1 hour was followed by solvent removal in a vacuum and distilling 402 parts of 2′-dimethylaminoethyl anthranilate over at 160° C./0.1 Torr.

275 parts of 2′-dimethylaminoethyl anthranilate were dissolved in a mixture of 190 parts of water and 230 parts of methanesulphonic acid and, after cooling to 5° C., admixed with 150 parts of a 40% aqueous solution of sodium nitrite added dropwise. After 3 hours, excess nitrite was destroyed by addition of sulphamic acid. A solution of 44 parts of resorcinol in 160 parts of water was then added, and the batch was raised to pH 5 with sodium acetate and subsequently stirred at room temperature for about 12 h to form a homogeneous solution. The dissolved dye conforms to the formula:

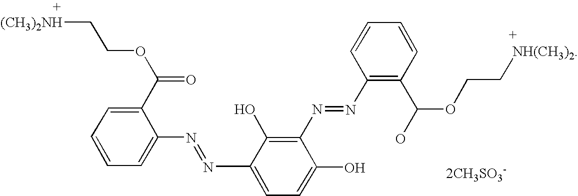

### PREPARATION EXAMPLE 3

1.25 kg of the dye solution of Preparation Example A1 are mixed with 7.75 kg of an approximately 10% liquid formulation of the dye of Preparation Example A1 at RT (=room temperature). This gives a stable dye solution which dyes paper in a yellowish brown hue (λ_{max.}=433 nm in water/acetic acid).

### PREPARATION EXAMPLE 4

4.2 kg of the dye solution of Preparation Example A1 are mixed with 2.5 kg of the dye solution of Preparation Example A36 at RT. The stable dye solution obtained dyes paper in a reddish yellow hue (λ_{max.}=450 nm in water/acetic acid).

### PREPARATION EXAMPLE 5

4.2 kg of the dye solution of Preparation Example A1 are mixed with 2.5 kg of the dye solution of Preparation Example A37 at RT. The stable dye solution obtained dyes paper in a reddish yellow hue (λ_{max.}=450 nm in water/acetic acid).

### Dyeing Prescriptions

### Dyeing Prescription A

70 parts of chemically bleached pinewood sulphite cellulose and 30 parts of chemically bleached birchwood sulphite cellulose are beaten into 2000 parts of water in a hollander. 1.5 parts of the liquid dye preparation of Preparation Example A1 are added to this stock. Paper is made therefrom after a mixing time of 20 minutes. The absorbent paper obtained in this way has a brown colour.

### Dyeing Prescription B

1.5 parts of the liquid dye preparation of Preparation Example A1 are added to 100 parts of chemically bleached sulphite cellulose beaten with 2000 parts of water in a hollander. After mixing through for 15 minutes, customary sizing is effected using resin size and aluminium sulphate. Paper made from this material exhibits a brown hue in each case.

### Dyeing Prescription C

An absorbent web of unsized paper is pulled at 40-50° C. through an aqueous dye solution consisting of 95 parts of water and 5 parts of the inventive dye solution of Preparation Example A1.

The excess dye solution is squeezed off by two rolls. The dried web of paper has a brown colour in each case.

The dye preparations of Preparation Examples A2-A35 can be used for dyeing similarly to Prescriptions A to C.

### Dyeing Prescription D

5 parts of the dye preparation of Preparation Example A1 are metered into 4000 parts of softened water at room temperature. 100 parts of prewetted woven cotton fabric are introduced into the bath, followed by heating to the boil over 30 minutes. The bath is held at the boil for an hour during which evaporated water is replaced from time to time. The dyeing is then removed from the liquor, rinsed with water and dried. The dyeing obtained has a brown colour.

The dye preparation of Preparation Examples A2-A35 can be used for dyeing cotton in a similar manner.

### Dyeing Prescription E

100 parts of freshly tanned and neutralized chrome grain leather are drummed for 30 minutes in a float of 250 parts of water at 55° C. and 0.5 part of the dye preparation made according to Preparation Example A1 and are treated for a further 30 minutes in the same bath with 2 parts of anionic fatliquor based on sulphonated fish oil. The leathers are conventionally dried and finished. The leather obtained has a level yellowish brown hue.

Further low-affinity, vegetable-retanned leathers can likewise be dyed according to known methods.

Dyeing can be done in a similar manner with dyes of Preparation Examples A2-A35.

### USE EXAMPLE F

15 kg of wastepaper (woody), 25 kg of bleached groundwood and 10 kg of unbleached sulphate pulp were beaten in a pulper to form a 3% aqueous pulp suspension. The pulp suspension was diluted to 2% in a dyeing vat. This suspension was then admixed in succession with 5% of kaolin and 1.25 kg of a 5% acetic acid solution of the dye of Preparation Example A1, reckoned on dry total fibre, by stirring. After 20 minutes the pulp in the mixing vat is admixed with 1% (based on absolutely dry fibre) of a resin size dispersion. The homogeneous pulp suspension was adjusted with alum to pH 5 on the paper machine just upstream of the headbox. The paper machine was used to produce an 80 g/m² brown bag paper with a machine finish.

Dyeing can be done in a similar manner with dyes of Preparation Examples A2-A35.

### USE EXAMPLE G

A dry stock containing 60% groundwood and 40% unbleached sulphite pulp is beaten with sufficient water and ground to 40 SR freeness in a hollander for the dry content to be just above 2.5% and then adjusted with water to a dry content of exactly 2.5% for the high-density pulp.

200 parts of this high-density pulp are admixed with 5 parts of a 0.25% aqueous solution of the dye of Preparation Example A1, stirred for about 5 min., admixed with 2% of resin size and 4% of alum, based on dry stock, and again stirred for some minutes until homogeneous. The material is diluted with about 500 parts of water to 700 parts by volume and used in a known manner to prepare sheets of paper by drainage on a sheet-former. These sheets of paper have an intense brown colour.

Dyeing can be done in a similar manner with dyes of Preparation Examples A2-A35.

### USE EXAMPLE H

An ink composition for inkjet printing consists of

6 parts of the dye of Preparation Example A1,
20 parts of glycerol and
74 parts of water.

This ink composition was then used for printing paper, papery substrates, textile fibre materials and plastic film/sheet by transferring the ink into the ink receptacle of a commercially available inkjet printer and using it to produce a single-coloured test print on the identified sheetlike materials.

Dyeing can be done in a similar manner with dyes of Preparation Examples A2-A35.

### USE EXAMPLE I

A roof batten composed of Norway spruce and a roof batten composed of beechwood are sawn into pieces 5 cm in length and one piece of the sprucewood roof batten and one piece of the beechwood roof batten are dipped into a dilute solution of the dye solution according to Preparation Example 1 (10 parts by weight of water and 1 part by weight of dye solution according to Preparation Example 1). Brownish roof batten pieces are obtained on drying.

Dyeing can then be done in a similar manner with dyes of Preparation Examples A2-A35.

1. A concentrated storage-stable colour-stable aqueous liquid dye solution comprising
(i) at least one cationizable dye of the formula (I): 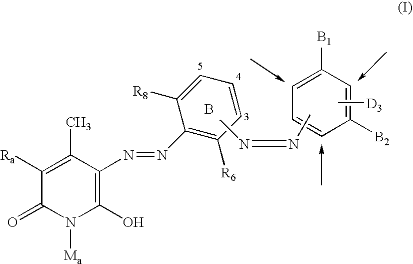
wherein B₁ and B₂ are independently —OH or NH₂ and D₃=H or a radical of the formula 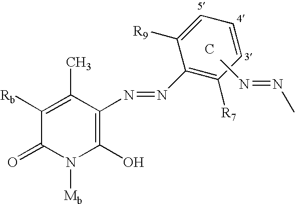
wherein
R₆, R₇, R₈ and R₉ are independently H or —SO₃H and
Mₐ and M_{b} are independently selected from the group consisting of: 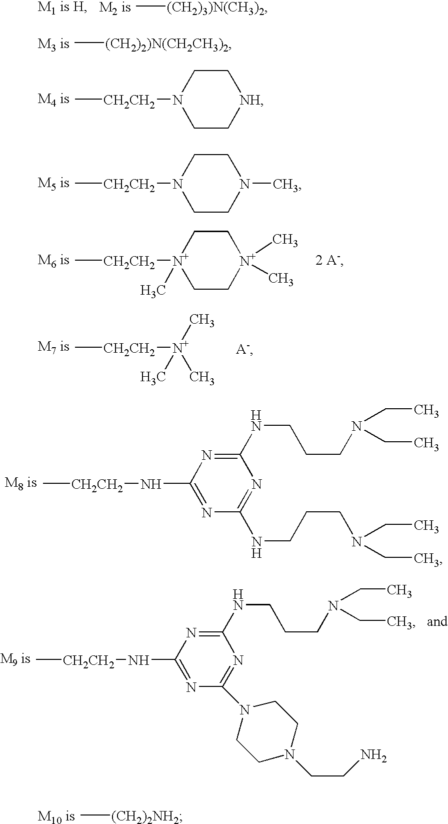
and
Rₐ and R_{b} are independently selected from the group consisting of: 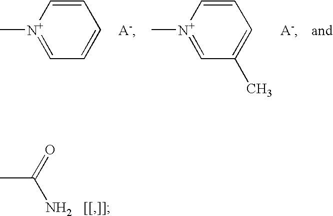
wherein A⁻ is a non-coloured anion which is the anion of an organic acid and/or the anion of an inorganic acid
(ii) an organic acid, an inorganic acid or a mixture thereof, and
(iii) water
wherein the concentrated storage-stable colour-stable aqueous liquid dye solution has an at most equimolar chloride ion fraction based on the dye present in the solution.

2. A concentrated storage-stable colour-stable aqueous liquid dye solution according to claim 1, wherein the pH is in the range of 2.0 to 4.0.

3. A concentrated storage-stable colour-stable aqueous liquid dye solution according to claim 1, wherein the solution further comprises a dye of the formula (II) 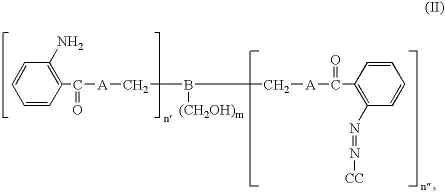
wherein
each A is independently —NH— or —O—,
B is a polyvalent group or atom,
n′ and n″ are natural numbers and the sum total of n′ and n″ is ≧2,
m is a natural number ≧0, and
CC is a group having the formula (c₁) or (c₂) 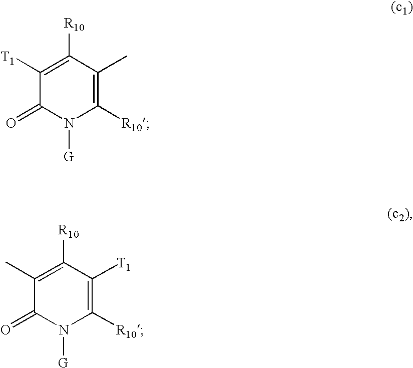
wherein
each R₁₀ is independently H; C₁₋₄alkyl; C₅₋₆cycloalkyl; phenyl, benzyl or phenylethyl,
each R₁₀′ is independently H; —OH or C₁₋₄alkyl
each T₁ is independently H; —CN; —COOR₁₅; CONR₁₆R₁₇; SO₂NR₁₆R₁₇; 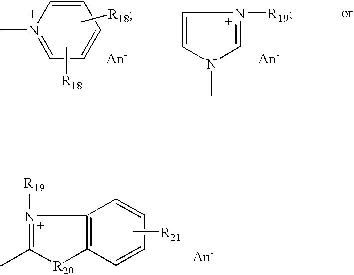
G is H; —R₁₁NHR₁₂ or —R₁₁NR₁₃R₁₄, wherein
R₁₁ is C₁₋₆alkylene or C₂₋₆alkenylene,
R₁₂, R₁₃, and R₁₄ are independently H; unsubstituted C₁₋₆alkyl; C₂₋₆alkyl substituted by OH, CN or halogen; phenyl-C₁₋₃alkyl, where the phenyl radical is optionally singly, doubly or triply substituted by substituents selected from the group consisting of chlorine, C₁₋₄alkyl and C₁₋₄alkoxy; unsubstituted C₅₋₆cycloalkyl or C₅₋₆cycloalkyl singly, doubly or triply substituted by C₁₋₄alkyl groups,
R₁₅ is C₁₋₆alkyl radical or phenyl-C₁₋₃alkyl radical,
R₁₆ and R₁₇ are independently H or a C₁₋₄alkyl radical,
R₁₈ is in each occurrence independently H; C₁₋₄alkyl radical; —NR₁₆R₁₇—(CH₂)₂₋₄—NR₁₆R₁₇ or —CONR₁₆R₁₇,
R₁₉ is a C₁₋₄alkyl radical or a hydroxy-C₁₋₄alkyl radical,
R₂₀ is —S— or —O—,
R₂₁ is a hydrogen atom or a C₁₋₄alkyl radical and
An⁻ is a non-coloured anion,
with the proviso that
(i) the sum total of n′, n″ and m is less than the number of valences of B,
(ii) when the sum total of n′ and n″=2, then m is ≧1,
(iii) when the sum total of n′ and n″ 3 and A=NH, then m≧1, and/or a dye of the formula (III) 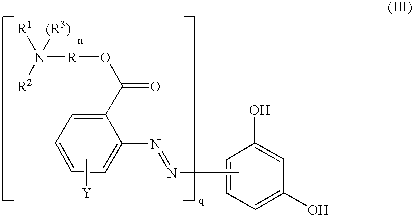
wherein
R¹, R² or R³ are independently H, CH₃, C₂H₅, n-C₃H₇, i-C₃H₇, n-C₄H₉, i-C₄H₉, sec-C₄H₉,
Rⁿ is —C₂H₄—, —C₃H₆—, —CH(CH3)CH₂— or —C₄H₆—
Y is hydrogen or nitro, and
q is 1 or 2.

4. A concentrated storage-stable colour-stable aqueous liquid dye solution according to claim 1, wherein the concentrated storage-stable colour-stable aqueous liquid dye solution contains up to 40% by weight of dye, from 0.5% to 25% by weight of the organic acid and is made up to 100% by weight with water.

5. A process for producing the concentrated storage-stable colour-stable aqueous liquid dye solution according to claim 1, comprising the step of filtering an aqueous solution or suspension of at least one crude cationic dye of the formula (I) using a semipermeable membrane, by applying a pressure to remove salts and synthesis by-products having molecular weights below 500 and some water until the chloride ion fraction is at most equimolar with regard to the dye of the formula (I) and wherein the step of filtering forms a permeate.

6. A process for producing the concentrated storage-stable colour-stable aqueous liquid dye solution according to claim 5 wherein the permeate is continuously or intermittently replaced or supplemented by water or buffer solution so that the dye concentration of the permeate does not change by more than 20%.

7. A process for producing the concentrated storage-stable colour-stable aqueous liquid dye solution according to claim 5, wherein the filtering step is done at a pH of between 5.5 and 6.5 and at a temperature of between 20 and 50 degrees Celsius.

8. A process for producing the concentrated storage-stable colour-stable aqueous liquid dye solution according to claim 5, further comprising the step of adjusting the pH to the range of 2.0 to 4.0.

9. (canceled)

10. A process for dyeing and/or printing a cellulosic material, comprising the step of contacting the cellulosic material with a concentrated storage-stable colour-stable aqueous liquid dye solution according to claim 1.

11. A process for producing an ink formulation for non-impact printing, comprising the step of mixing a concentrated storage-stable colour-stable aqueous liquid dye solution according to claim 1 with at least one other ink formulation compound.

12. A substrate that has been dyed or printed with a concentrated storage-stable colour-stable aqueous liquid dye solution according to claim 1.

13. A process for producing the concentrated storage-stable colour-stable aqueous liquid dye solution according to claim 7, wherein the filtering step is done at a pH of between 5.9 and 6.1.

14. A process for producing the concentrated storage-stable colour-stable aqueous liquid dye solution according to claim 7, wherein the filtering step is done at a temperature of between 30 and 35 degrees Celsius.

15. A process according to claim 10 for dyeing and/or printing a cellulosic material, wherein the cellulosic material is selected from the group consisting of: paper, paperboard, card and wood.

16. A process according to claim 11 wherein the ink formulation is for inkjet printing.

17. A cellulosic material dyed and/or printed by a process according to claim 10.

18. An ink formulation produced by the process according to claim 11.

19. A concentrated storage-stable colour-stable aqueous liquid dye solution according to claim 1, wherein the solution further comprises a dye of the formula (II) 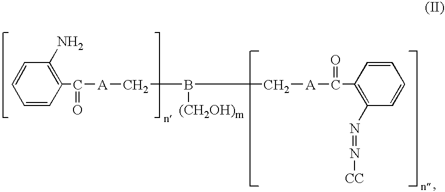
wherein
each A is independently —NH— or —O—,
B is a polyvalent group or atom,
n′ and n″ are natural numbers and the sum total of n′ and n″ is ≧2,
m is a natural number ≧0, and
CC is a group having the formula (c₁) or (c₂) 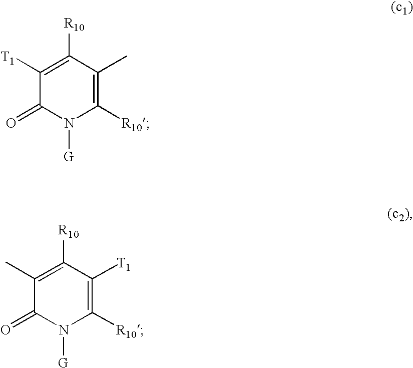
wherein
each R₁₀ is independently H; C₁₋₄alkyl; C₅₋₆cycloalkyl; phenyl, benzyl or phenylethyl,
each R₁₀′ is independently H; —OH or C₁₋₄alkyl
each T₁ is independently H; —CN; —COOR₁₅; CONR₁₆R₁₇; SO₂NR₁₆R₁₇; 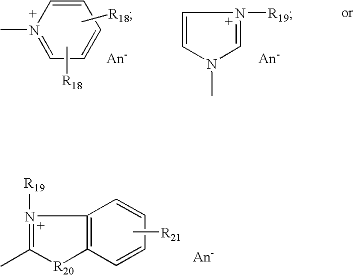
G is H; —R₁₁NHR₁₂ or —R₁₁NR₁₃R₁₄, wherein
R₁₁ is C₁₋₆alkylene or C₂₋₆alkenylene,
R₁₂, R₁₃, and R₁₄ are independently H; unsubstituted C₁₋₆alkyl; C₂₋₆alkyl substituted by OH, CN or halogen; phenyl-C₁₋₃alkyl, where the phenyl radical is optionally singly, doubly or triply substituted by substituents selected from the group consisting of chlorine, C₁₋₄alkyl and C₁₋₄alkoxy; unsubstituted C₅₋₆cycloalkyl or C cycloalkyl singly, doubly or triply substituted by C₁₋₄alkyl groups,
R₁₅ is C₁₋₆alkyl radical or phenyl-C₁₋₃alkyl radical,
R₁₆ and R₁₇ are independently H or a C₁₋₄alkyl radical,
R₁₈ is in each occurrence independently H; C₁₋₄alkyl radical; —NR₁₆R₁₇—(CH₂)₂₋₄—NR₁₆R₁₇ or —CONR₁₆R₁₇,
R₁₉ is a C₁₋₄alkyl radical or a hydroxy-C₁₋₄alkyl radical,
R₂₀ is —S— or —O—,
R₂₁ is a hydrogen atom or a C₁₋₄alkyl radical and
An⁻ is a non-coloured anion,
with the proviso that
(i) the sum total of n′, n″ and m is less than the number of valences of B,
(ii) when the sum total of n′ and n″=2, then m is ≧1,
(iii) when the sum total of n′ and n″=3 and A=NH, then m≧1.

20. A concentrated storage-stable colour-stable aqueous liquid dye solution according to claim 1, wherein the solution further comprises a dye of the formula (III) 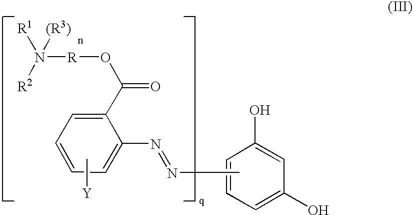
wherein
R¹, R² or R³ are independently H, CH₃, C₂H₅, n-C₃H₇, i-C₃H₇, n-C₄H₉, i-C₄H₉, sec-C₄H₉,
Rⁿ is —C₂H₄—, —C₃H₆—, —CH(CH3)CH₂— or —C₄H₆—
Y is hydrogen or nitro, and
q is 1 or 2.
